(19) United States
(12) Patent Application Publication
(10) Pub. No.: US 2012/0192834 A1
(43) Pub. Date: Aug. 2, 2012

(54) COMBUSTION METHOD AND APPARATUS

(76) Inventor: David Tonery, London (GB)

(21) Appl. No.: 13/383,479

(22) PCT Filed: Jul. 9, 2010
(86) PCT No.: PCT/GB10/01322

§ 371 Date: Apr. 6, 2012

(30) Foreign Application Priority Data
Jul. 11, 2009 (GB) 0912081.7

(51) Int. Cl. F02M 35/10

(52) U.S. Cl. 123/434

(57) ABSTRACT

A method of operating a combustion apparatus (10) having an engine (12) and an air processing unit (14) comprises: separating inlet air in the air processing unit (14) into oxygen enriched air and nitrogen enriched air; delivering oxygen enriched air to the engine (12) and initiating homogeneous charge compression ignition combustion, and then reducing the mass of oxygen enriched air being delivered to the engine (12) and maintaining homogeneous charge compression ignition combustion.

### FIELD OF THE INVENTION

The present invention relates to a method of operating a combustion apparatus, and in particular to a method of initiating and maintaining Homogeneous Charge Compression Ignition (HCCI) combustion, also known as Controlled Auto-Ignition (CAI). The present invention also relates to a combustion apparatus.

### BACKGROUND TO THE INVENTION

There are considerable environmental concerns over the increasing use of fossil fuels, and efforts are being made to reduce harmful emissions from, for example, internal combustion engines while seeking to maximise fuel efficiency and engine performance. In the automotive industry developments are ongoing to seek to improve the quality of exhaust gases emitted from vehicles by reducing the percentage content of environmental toxins, such as unburned hydrocarbons, carbon monoxide, nitrogen oxides and the like. For example, developments in catalyst materials and engine management systems seek to lower such emissions. However, it is often the case that efforts to reduce emissions from internal combustion engines adversely affects engine performance, and result in significant cost increases.

There are two main types of engine in common use: the spark ignition engine and the compression ignition engine.

Spark ignition engines, which are generally associated with gasoline fuel, function by introducing a mixture of air and fuel into a combustion cylinder, and igniting the mixture via a spark, which is typically provided by a spark plug. Combustion will propagate through the combustion cylinder from the spark ignition point, causing the combustion temperature to continually increase during the combustion process, resulting in high peak combustion temperatures. In spark ignition engines a throttle is provided within the intake to the engine which functions to modulate the density and thus the mass of the charge entering the combustion cylinder.

As noted above, typical emissions from combustion include nitrogen oxides, unburned hydrocarbons and carbon monoxide. In most cases these emissions are processed via suitable catalysts which reduce nitrogen oxides to nitrogen and oxygen, and oxidise unburned hydrocarbons to water and carbon dioxide, and carbon monoxide to carbon dioxide. Three-way catalysts are available for this purpose. With a view to increase fuel efficiency it would be preferable to operate with a lean fuel/air ratio, However, with a lean fuel/air ratio there will be excess oxygen which compromises the effect of the catalyst to process the nitrogen oxides, resulting in emissions which exceed legislated limits. It is therefore generally understood that spark ignition engines are operated at near stoichiometric fuel/air ratios in order to reduce the oxygen content, permitting effective use of an associated catalyst.

Compression ignition engines, which are generally associated with diesel fuel, function by introducing air into a combustion cylinder, compressing the air by a piston to cause a temperature increase, and then injecting fuel into the combustion chamber, wherein the fuel is caused to combust by the high temperatures. Combustion will propagate through the combustion cylinder from the initial fuel ignition point, causing the combustion temperature to continually increase during the combustion process, resulting in high peak combustion temperatures. Compression ignition engines are generally controlled by modulating the volume of fuel being injected into the cylinder. Accordingly, this type of control makes it difficult to modify the fuel/air ratio to accommodate preferences in fuel efficiency, emissions and the like.

In both spark ignition and compression ignition engines, emissions, such as nitrogen oxides, hydrocarbons and carbon monoxide are generally controlled using suitable catalysts. However, it is understood that nitrogen oxides are the most difficult to remove from exhaust gases. As noted above, the solution in spark ignition engines is to use near stoichiometric combustion and three way catalysts. However, this option is not available for compression ignition engines where lean combustion is normal. One approach is to use an oxidation catalyst for reducing hydrocarbon and carbon monoxide levels followed by a second catalytic system known as a lean nitric oxide trap. However, this approach tends to be expensive and difficult to operate reliably over the complete range of engine use.

Another approach to reduce nitrogen oxides in both spark ignition and compression ignition engines is to dilute the fresh charge entering the cylinder with cooled inert recycled exhaust gases, known as Exhaust Gas Recirculation (EGR). Recycled exhaust gases are composed mainly of nitrogen, water vapour and carbon dioxide and consequently cannot participate in combustion of the fresh charge, but instead function to absorb heat during combustion, reducing the peak cylinder temperatures and thus the rate of formation of nitrogen oxides. However, the introduction of recycled exhaust gases reduces the effective power available for each charge, which may affect overall engine performance.

A third known engine type is the Homogeneous Charge Compression Ignition (HCCI) engine in which fuel and air is mixed early, as in a spark ignition engine, to give a homogeneous charge which is introduced into a combustion cylinder. Combustion is not, however, initiated by a spark, but is instead initiated by controlling the charge temperature, pressure and composition at the beginning of the compression stroke (achieved by a piston within the cylinder) such that by the end of the compression stroke the charge has reached a sufficiently high temperature to auto-ignite, as in a compression ignition engine. With the right conditions combustion initiates virtually simultaneously at many locations in the cylinder, rather than from a point source, resulting in complete combustion at relatively low peak combustion temperatures. Further, spark and compression ignition discussed above function by flame combustion, in which a flame is generated which travels from the ignition point through the combustion chamber resulting in accumulation of pressure behind the flame causing an increase in temperature. HCCI combustion, however, functions by flameless combustion and as such there is no pressure increase or spike in temperature. The lower peak temperatures therefore results in a lower formation rate of nitrogen oxides.

However, HCCI engines are very difficult to control, especially to initiate HCCI operation, and then to maintain this while still meeting acceptable fuel efficiency and exhaust emissions.

The present applicant in WO 20071034168 has proposed an air intake system in which intake air is separated into an oxygen enriched air stream and a nitrogen enriched air stream, wherein the oxygen enriched air stream is delivered to an HCCI engine.

JP 2007-285281 discloses an internal combustion engine that includes an air separator configured to separate inlet air into an oxygen enriched stream and a nitrogen enriched stream. In normal engine conditions the nitrogen enriched stream is delivered to the engine to facilitate combustion, and the oxygen enriched stream is delivered to an exhaust catalyst system to assist oxidation of exhaust products. When an engine acceleration event occurs the oxygen enriched stream is temporarily diverted to be supplied to the engine with the nitrogen enriched stream.

### SUMMARY OF THE INVENTION

According to a first aspect of the present invention there is provided a method of operating a combustion apparatus having an engine and an air processing unit, the method comprising:

separating inlet air in the air processing unit into oxygen enriched air and nitrogen enriched air;

delivering oxygen enriched air to the engine and initiating homogeneous charge compression ignition combustion; and then

reducing the mass of oxygen enriched air being delivered to the engine and maintaining homogeneous charge compression ignition combustion.

The air processing unit may be configured to produce nitrogen enriched air which contains a proportion of oxygen. The nitrogen enriched air may contain a larger proportion of nitrogen and a lower proportion of oxygen than ambient air. The air processing unit may be configured to produce oxygen enriched air which contains a proportion of nitrogen. The oxygen enriched air may contain a larger proportion of oxygen and a lower proportion of nitrogen than ambient air. The air processing unit may be configured to produce oxygen enriched air and nitrogen enriched air with required proportions of oxygen and nitrogen. The air processing unit may be configured to produce oxygen enriched air with between 30 to 100% oxygen purity, for example between 50 to 95% oxygen purity, between 70 to 95% oxygen purity, between 90 to 95% oxygen purity or the like.

Controlling a combustion apparatus in accordance with the method according to the first aspect may permit homogeneous charge compression ignition (HCCI), also known as controlled auto-ignition (CAI), operation of the engine to be initiated, and once initiated maintained. Without wishing to be bound by theory, the present applicant considers that the increase in oxygen content in the combustion chamber increases the volatility of the air and fuel mixture promoting the initiation of combustion.

The step of reducing the mass of oxygen enriched air following initiating HCCI operation advantageously permits the peak combustion temperatures to be restricted.

Nitrogen enriched air may be delivered to the engine simultaneously with oxygen enriched air. Nitrogen enriched air may be supplied to the engine during the step of initiating HCCI combustion. Nitrogen enriched air may be supplied to the engine when the mass of oxygen enriched air is reduced after HCCI combustion has been initiated. Reducing the mass of oxygen enriched air and delivering nitrogen enriched air to the engine at this stage may permit peak temperatures to be dampened due to heat absorption by the inert nitrogen, thus assisting to maintain HCCI operation while minimising the formation of oxides of nitrogen.

The engine may be configured to combust any suitable fuel, such as a fossil fuel, hydrogen, biofuel, solid fuel or the like. The engine may define, at least partially, a fuel cell.

The method may comprise operating the engine exclusively by HCCI combustion.

The method may comprise the step of initially delivering at least the nitrogen enriched air to the engine and operating the engine by one of compression ignition and spark ignition combustion, prior to the step of initiating HCCI combustion.

Initially operating the engine using at least the nitrogen enriched air during one of compression ignition and spark ignition combustion may permit the engine to warm up and maintain a sufficient operating temperature. When HCCI operation is required, for example when a threshold engine temperature has been reached, the mass of oxygen enriched air delivered to the engine may be increased to assist to stimulate HCCI operation. When spark ignition combustion is initially utilised, HCCI operation may be initiated at least in part by deactivating sparking means, such as a spark plug, associated with the engine. The present applicant considers that the increase in oxygen accelerates the combustion speed providing an enabler to transition from flame combustion, such as spark or compression ignition, to HCCI combustion.

The use of nitrogen enriched air may assist to prevent excessive peak combustion temperatures due to the inert nature of nitrogen which will function to absorb heat. This reduction in peak combustion temperatures may assist to minimise the formation of oxides of nitrogen, which may permit minimal downstream treatment of exhaust gases to reduce nitrogen oxides. Accordingly, the use of nitrogen enriched air may eliminate or minimise the requirement to operate at near stoichiometric fuel/air ratios, as is known in conventional spark ignition engines, permitting leaner fuel/air ratios to be utilised and providing advantages in terms of fuel economy.

The method may comprise initially delivering only nitrogen enriched air to the engine, such that the mass of oxygen enriched air delivered is zero. Alternatively, a proportion of oxygen enriched air may also be initially delivered to the engine, which may permit the engine to warm up quicker, prior to the step of initiating HCCI combustion. Further, a proportion of oxygen enriched air may permit exhaust gas temperature to be increased quicker. This may permit exhaust gas treatment apparatus, such as a catalyst apparatus to heat up quicker to reach efficient operating conditions. The step of delivering oxygen enriched air to the engine and initiating HCCI combustion may comprise the step of increasing the mass of oxygen enriched air being delivered to the engine. When the mass of oxygen enriched air being delivered to the engine is increased to assist to stimulate HCCI operation, the mass of nitrogen enriched air may be reduced, either entirely or partially. Alternatively, the mass of nitrogen enriched air may be increased.

Delivering oxygen enriched air to the engine during one of compression ignition and spark ignition operation may permit a leaner operation of the engine, and thus increase fuel efficiency. The present applicant has discovered that an enriched supply of oxygen may permit an increase in power density of up to 40% with an increase in oxygen of less than 10%, typically around 9%. The use of oxygen enriched air may permit more complete combustion of fuel, and may minimise the mass of air being introduced, thus minimising the mass of exhaust gases created. Appropriate masses of nitrogen and oxygen enriched air may be mixed to provide a required air composition to be delivered to the engine. The combustion apparatus may comprise a sensor arrangement configured to provide an indication of oxygen and nitrogen content to permit appropriate mixing to generate the required composition.

HCCI operation may be initiated when particular engine conditions are satisfied. For example, HCCI operation may be initiated and maintained over particular engine temperature ranges, power output ranges or the like. This arrangement may permit switching between compression ignition or spark ignition and HCCI to provide optimum running conditions, such as optimum fuel efficiency, minimal emissions and the like. In one arrangement, HCCI operation may be initiated over low to high engine powers, and compression ignition or spark ignition may be initiated during idling and warm-up conditions. Compression ignition or spark ignition may be initiated during high engine power outputs.

The method may comprise the step of heating air, such as oxygen enriched air or nitrogen enriched air being supplied to the engine to achieve required air conditions. The method may comprise the step of heating nitrogen enriched air prior to being delivered to the engine during HCCI operation. Air to be supplied to the engine may be selectively heated to permit a degree of temperature control. This arrangement may advantageously assist to permit control of the properties of the air being delivered to the engine, which is a significant factor in stimulating and maintaining HCCI combustion.

In one embodiment air to be supplied to the engine may be heated via waste heat from engine exhaust gases. Alternatively, or additionally, air may be heated by any one or combination of, for example: waste heat from an engine cooling system; waste heat from a vehicle occupant climate control system; heat generated by an electrically or mechanically operated heat exchanger; heat from an induction heater; heat from combustion within a separate combustion apparatus; heat generated from a chemical reaction.

The combustion apparatus may comprise a cooling arrangement configured to cool at least a proportion of air being delivered to the engine. The cooling arrangement may be used during compression ignition or spark ignition operation of the engine, which may assist to restrict peak combustion temperatures, for example to minimise formation of oxides of nitrogen.

The cooling arrangement may be used in combination with an air heating arrangement, such as a heating arrangement based on waste exhaust heat, in order to permit accurate modulation of the air temperature. For example, the method may comprise heating a proportion of the air to be delivered to the engine, cooling a proportion of air to be delivered to the engine, and subsequently mixing appropriate proportions of the heated and cooled air to achieve the required air temperature.

The cooling arrangement may comprise any one or combination of, for example: an air cooled arrangement, water cooled arrangement, fan arrangement, refrigerant arrangement, water injection cooling or the like.

The method may comprise the step of recycling combustion exhaust gases to the engine. This exhaust gas recirculation may be utilised to assist to control peak combustion temperatures as the exhaust gases, being primarily inert, will absorb heat within the engine, and will not contribute to combustion therein.

The recycled exhaust gases may be recycled substantially directly to the engine, such that the exhaust gases may contribute to increasing the temperature of the air supplied to the engine. This arrangement may be utilised during HCCI operation of the engine in order to assist to create preferential air temperature conditions to maintain, or initiate, HCCI combustion.

The recycled exhaust gases may be cooled prior to being delivered to the engine. This arrangement may be utilised during compression ignition or spark ignition operation of the engine.

Exhaust gases may be recirculated from the exhaust outlet of the engine. Alternatively, exhaust gasses may be captured and retained within a combustion chamber of the engine, which is known as internal exhaust gas recirculation. Exhaust gases may be stored in a vessel and recirculated on demand, for example by a control system. Exhaust gases may be recirculated from a separate combustion apparatus.

The method may comprise the step of delivering oxygen enriched air to a catalyst arrangement provided to process exhaust products from the engine. This arrangement may provide sufficient oxygen to permit exhaust products, such as hydrocarbons and carbon monoxide, to be appropriately oxidised within the catalyst arrangement. This may be advantageous in conditions where nitrogen enriched air is supplied to the engine, which otherwise may provide insufficient oxygen following combustion for the necessary catalytic oxidisation of exhaust products.

The method may comprise the step of supplying oxygen enriched air to a catalyst arrangement while nitrogen enriched air is supplied to the engine. The method may comprise the step of supplying oxygen enriched air to a catalyst arrangement during compression ignition or spark ignition operation of the engine. Oxygen enriched air may be supplied to a catalyst arrangement during HCCI operation of the engine.

The method may comprise the steps of delivering oxygen enriched air to a catalyst arrangement, and then diverting at least a proportion of the oxygen enriched air to the engine to assist to initiate HCCI operation. The method may comprise the further step of re-diverting at least a proportion of the oxygen enriched air being supplied to the engine to the catalyst arrangement after initiation of HCCI combustion within the engine.

The method may comprise the step of compressing air being supplied to the engine. The combustion apparatus may comprise a compressor arrangement configured to compress air to be delivered to the engine. The compressor arrangement may comprise a supercharger, turbocharger or the like. This arrangement may permit forced induction of the air into the engine. This may assist to increase engine power. This arrangement may also assist to increase the temperature of the air. This may be advantageous for HCCI engine operation.

The method may comprise the step of bypassing a volume of air past the compressor arrangement. This may assist to provide more accurate control of the properties of the air being supplied to the engine. The combustion apparatus may comprise an engine having a compression ratio in the range of, for example, 6:1 to 28:1.

The combustion apparatus may comprise a variable compression engine. Providing variable compression within the engine may support initiation and assist to maintain HCCI operation by permitting more accurate control of the combustion conditions.

The engine of the combustion apparatus may comprise a variable valve timing arrangement. Variable valve timing may assist to permit control of the compression ratio within the engine, which may assist to initiate and maintain HCCI combustion. Variable valve timing may also assist in control over internal exhaust gas recirculation.

The air processing unit may comprise a separating media configured to separate nitrogen and oxygen. The separating media may comprise a molecular filter arrangement. The separating media may comprise at least one membrane. The separating media may comprise a zeolite material. The separating media may comprise a plurality of nanotubes.

The air processing unit may comprise a compressor configured to compress inlet air to be delivered through the separation media. The compressor may be operated by the engine. The compressor may comprise, for example, a supercharger, turbocharger or the like. The compressor may be operated by an external drive source, such as an external motor, engine or the like.

The air processing unit may comprise an air cooler. This arrangement may permit inlet air to be cooled to within a preferred temperature range to maximise the effect of separation of nitrogen and oxygen. This may be advantageous in embodiments where a compressor is used, which will increase the temperature of the air being compressed therein.

The air processing unit may comprise an air filter.

The air processing unit may comprise an air dryer. This arrangement may be provided in combination with any separation media, such as zeolite material which advantageously increases efficiency when the moisture content of the air is reduced. The air dryer may comprise a desiccant air dryer. The air dryer may be at least partially provided by or within, or defined by, a portion of the air processing unit. For example, the air dryer may be at least partially provided by or within, or defined by, a canister which contains a separation media, such as a zeolite material.

The air processing unit may comprise a storage arrangement configured to store processed air. The air processing unit may comprise at least one surge tank adapted to receive at least one of oxygen enriched air and nitrogen enriched air. The air processing unit may comprise a zeolite material configured to store an air component adsorbed thereby. The storage arrangement may permit sufficient air supply during peak demand from the engine. The storage arrangement may comprise a separation media, such as a zeolite material.

The air processing unit may comprise:

a canister containing a plurality of chambers each comprising a zeolite material;

an air inlet configured to deliver air to be processed to the canister;

wherein the canister and the air inlet are relatively moveable to sequentially align the plurality of zeolite chambers with the air inlet.

The zeolite material may be adapted to adsorb one of nitrogen and oxygen from the inlet air. In this way the element being adsorbed may be retained within the zeolite material, and the remaining element(s) passing therethrough to subsequently be released from the canister and passed for use.

In use, the zeolite material within at least one chamber aligned with the air inlet will adsorb one of nitrogen and oxygen from the inlet air, while at least one chamber misaligned with the air inlet will release the adsorbed element, in preparation for a subsequent absorption cycle. Accordingly, by sequentially aligning the zeolite chambers with the air inlet a continuous cycling operation may be achieved in which at least one zeolite chamber is adsorbing a selected element, and at least one other zeolite chamber is releasing the adsorbed selected element. This may permit rapid and substantially continuous processing of the inlet air to provide oxygen enriched air and nitrogen enriched air.

The zeolite material may be configured to adsorb a selected element when the associated chamber is pressurised. This may be achieved by pressurising the inlet air to be processed. The zeolite material may be configured to release the selected adsorbed element when the pressure of the associated chamber is reduced.

The canister may be configured to be rotatable to sequentially align the zeolite chambers with the air inlet.

The combustion apparatus may be provided in a vehicle, wherein at least some components of the air processing unit are mounted on a component of the vehicle. In one arrangement at least some components of the air processing unit are mounted on a vehicle component associated with a compartment for containing the engine. At least some components of the air processing unit may be mounted on a closure component of an vehicle engine compartment, such as a vehicle bonnet.

An air separation media may be mounted on a vehicle component. Oxygen and/or nitrogen surge tanks may be mounted on a vehicle component.

According to a second aspect of the present invention there is provided a combustion apparatus comprising:

an engine;

an air processing unit adapted to separate inlet air into nitrogen enriched air and oxygen enriched air to be selectively delivered to the engine,

wherein the combustion apparatus is configurable between first and second configurations, wherein:
in the first configuration oxygen enriched air is delivered to the engine and homogeneous charge compression ignition combustion is initiated; and
in the second configuration the mass of oxygen enriched air being delivered to the engine is reduced and homogeneous charge compression ignition combustion is maintained.

According to a third aspect of the present invention there is provided a combustion apparatus comprising:

an engine;

an air processing unit configured to separate inlet air into oxygen enriched air and nitrogen enriched air; and

a control arrangement configured to deliver oxygen enriched air to the engine and initiate homogeneous charge compression ignition combustion, and then reduce the mass of oxygen enriched air being delivered to the engine and maintaining homogeneous charge compression ignition combustion.

It should be understood that the combustion apparatus defined above in the second and third aspects may be utilised to carry out the method according to the first aspect and as such features and elements related to the combustion apparatus defined in relation to the first aspect may apply to the second and third aspects.

According to a fourth aspect of the present invention there is provided a vehicle comprising the combustion apparatus according to the second or third aspects.

According to a fifth aspect of the present invention there is provided a method of operating a combustion apparatus having an engine and an air processing unit, the method comprising:

separating inlet air in the air processing unit into oxygen enriched air and nitrogen enriched air;

initially delivering at least the nitrogen enriched air to the engine and operating the engine by one of compression ignition and spark ignition combustion;

increasing the mass of oxygen enriched air being delivered to the engine and initiating homogeneous charge compression ignition combustion; and then reducing the mass of oxygen enriched air being delivered to the engine and maintaining homogeneous charge compression ignition combustion.

The present invention according to the fifth aspect may permit very accurate control of the composition of air being delivered to the engine to control the relative proportions of the separated nitrogen and oxygen enriched air communicated to the engine in order to assist to stimulate and maintain HCCI operation, for example over a range of engine outputs.

According to a sixth aspect of the present invention there is provided a combustion apparatus comprising:

an engine;

an air processing unit adapted to separate inlet air into nitrogen enriched air and oxygen enriched air to be selectively delivered to the engine,

wherein the combustion apparatus is configurable between first, second and third configurations, wherein:
in the first configuration at least the nitrogen enriched air is delivered to the engine and the engine is operated by one of compression ignition and spark ignition combustion:
in the second configuration the mass of oxygen enriched air being delivered to the engine is increased and homogeneous charge compression ignition combustion is initiated; and
in the third configuration the mass of oxygen enriched air being delivered to the engine is reduced and homogeneous charge compression ignition combustion is maintained.

According to a seventh aspect of the present invention there is provided a combustion apparatus comprising:

an engine;

an air processing unit configured to separate inlet air into oxygen enriched air and nitrogen enriched air; and

a control arrangement configured to initially deliver at least the nitrogen enriched air to the engine and operate the engine by compression ignition or spark ignition combustion, subsequently increase the mass of oxygen enriched air being delivered to the engine and initiating homogeneous charge compression ignition combustion, and then reduce the mass of oxygen enriched air being delivered to the engine and maintaining homogeneous charge compression ignition combustion.

According to an eighth aspect of the present invention there is provided a gas processing unit a comprising:

a canister containing a plurality of chambers each comprising a zeolite material, wherein the zeolite material is adapted to adsorb a selected component from a gas being processed:

a gas inlet configured to deliver a gas to be processed to the canister;

wherein the canister and the gas inlet are relatively moveable to sequentially align the plurality of zeolite chambers with the gas inlet.

The zeolite material may be adapted to adsorb a gas component from the gas being processed.

In one embodiment the zeolite material may be adapted to adsorb one of nitrogen and oxygen from air. In this way the gas element being adsorbed may be retained within the zeolite material, and the remaining element(s) passing therethrough to subsequently be released from the canister and passed for use.

In use, the zeolite material within at least one chamber aligned with the gas inlet will adsorb a gas component from the inlet gas to be processed, while at least one chamber misaligned with the gas inlet will release the adsorbed gas component, in preparation for a subsequent absorption cycle. Accordingly, by sequentially aligning the zeolite chambers with the gas inlet a continuous cycling operation may be achieved in which at least one zeolite chamber is adsorbing a selected gas component, and at least one other zeolite chamber is releasing the adsorbed selected component. This may permit rapid and substantially continuous processing of the inlet gas.

The zeolite material may be configured to adsorb a selected element when the associated chamber is pressurised. This may be achieved by pressurising the inlet gas to be processed. The zeolite material may be configured to release the selected adsorbed element when the pressure of the associated chamber is reduced.

The canister may be configured to be rotatable to sequentially align the zeolite chambers with the air inlet.

According to a ninth aspect of the present invention there is provided a vehicle comprising:

an engine compartment;

an engine mounted within the engine compartment; and

an air processing unit comprising a separation media configured to separate inlet air into oxygen enriched air and nitrogen enriched air to be selectively delivered to the engine, wherein the separation media is mounted on a portion of the engine compartment.

In one embodiment the separation media is mounted on a closure component of the engine compartment, such as a bonnet.

According to a tenth aspect of the present invention there is provided a method of operating a combustion apparatus having an engine and an air processing unit, the method comprising:

separating inlet air in the air processing unit into oxygen enriched air and nitrogen enriched air;

delivering oxygen enriched air to the engine an initiating homogeneous charge compression ignition combustion; and

diverting at least a proportion of the oxygen enriched air being supplied to the engine to an exhaust gas catalyst arrangement after initiation of HCCI combustion within the engine.

The method may comprise the step of initially delivering at least nitrogen enriched air to the engine and operating the engine by one of compression ignition and spark ignition combustion, prior to the step of initiating HCCI combustion.

The method may comprise the step of delivering oxygen enriched air to the exhaust gas catalyst arrangement prior to the step of initiating HCCI combustion, and then diverting at least a proportion of oxygen enriched air being delivered to the catalyst arrangement to be delivered top the engine to initiate HCCI combustion.

### BRIEF DESCRIPTION OF THE DRAWINGS

These and other aspect of the present invention will now be described, by way of example only, with reference to the accompanying drawings, in which:

FIG. 1 is a diagrammatic representation of a combustion apparatus in accordance with an embodiment of the present invention:

FIG. 2 is a diagrammatic representation of an air processing unit in accordance with an embodiment of the present invention;

FIG. 3 is a diagrammatic representation of an air processing unit in accordance with an alternative embodiment of the present invention;

FIG. 4 is a diagrammatic representation of an air processing unit in accordance with a further alternative embodiment of the present invention;

FIGS. 5 and 6 demonstrate a mounting arrangement for components of an air processing unit in accordance with an embodiment of the present invention;

### DETAILED DESCRIPTION OF THE DRAWINGS

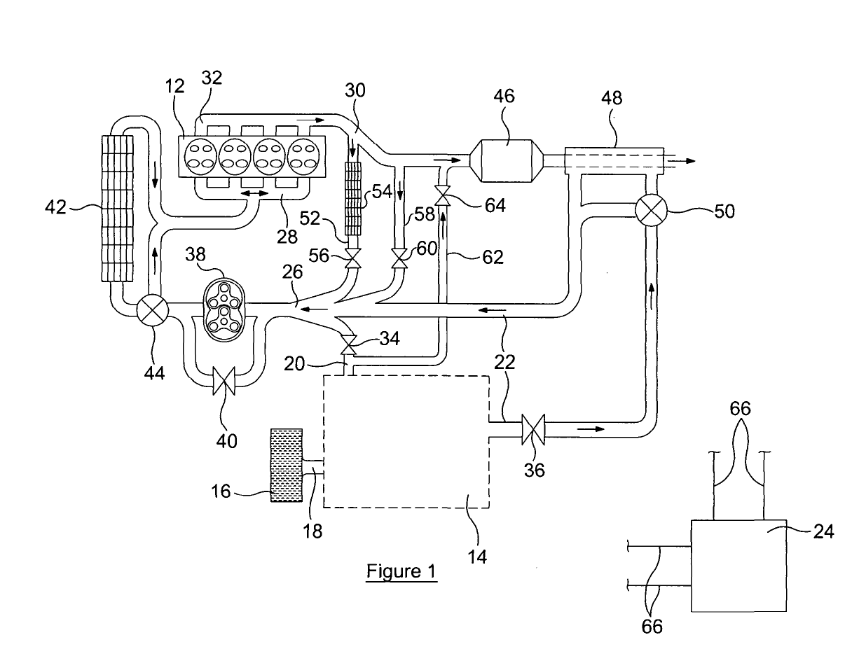

Reference is first made to FIG. 1 in which there is shown a diagrammatic representation of a combustion apparatus, generally indicated by reference numeral 10, in accordance with an embodiment of the present invention. The combustion apparatus 10 comprises an internal combustion engine 12, which in this case is a four cylinder engine, and as will be described in further detail below is configured to switch between spark ignition and homogeneous charge compression ignition (HCCI) modes of operation. The apparatus further comprises an air processing unit 14 adapted to separate ambient air, received via an air filter 16 and inlet conduit 18, into oxygen enriched air and nitrogen enriched air. Oxygen enriched air is delivered from the air processing unit 14 via outlet conduit 20, and nitrogen enriched air is delivered from the air processing unit 14 via outlet conduit 22.

The apparatus 10 further comprises an engine air inlet conduit 26 in communication with an inlet manifold 28 of the engine 12, and an engine exhaust conduit 30 in communication with an exhaust manifold 32 of the engine 12. Both the oxygen enriched air conduit 20 and the nitrogen enriched air conduit 22 are in communication with the engine air inlet conduit 26, such that both oxygen enriched air and nitrogen enriched air may be supplied to the engine 12, as required. The oxygen enriched air conduit 20 comprises a valve 34 adapted to control communication with the engine air inlet conduit 26. Similarly, the nitrogen enriched air conduit 22 comprises a valve 36 adapted to control communication with the engine air inlet conduit 26. Valve 36 may function as a throttle to control engine power.

A supercharger 38 is provided in the engine air inlet conduit 26 and is configured to pressurise inlet air for achieving forced air induction to the engine 12, as is known in the art. A bypass valve 40 is provided to permit selective bypass of the supercharger 38.

An air cooler 42 is associated with the air inlet conduit 26 and in use is adapted to cool inlet air prior to being delivered to the engine 12. An air cooler bypass valve 44 is provided and in use is configured to selectively divert at least a proportion of inlet air through the air cooler 42. Accordingly, selective control of the air cooler bypass valve 44 may permit accurate control of the temperature of the air being delivered to the engine 12.

A catalyst assembly 46 is provided within the exhaust conduit 30 for treating exhaust gases from the engine 12. The catalyst 46 may be configured to oxidise unburned hydrocarbons, carbon monoxide or the like. The catalyst 46 may be arranged in a known manner.

The apparatus 10 further comprises a heat exchanger 48 configured to accommodate heat transfer between exhaust gases flowing through the exhaust conduit 30 and nitrogen enriched air flowing from conduit 22 delivered from the air separator 22. A heat exchanger bypass valve 50 is provided and in use is configured to selectively divert nitrogen enriched air from conduit 22 through the heat exchanger 48. Accordingly, selective control of bypass valve 50 may permit accurate control of the temperature of the nitrogen enriched air prior to being delivered towards the engine 12 via inlet conduit 26.

A first exhaust gas recirculation (EGR) conduit 52 extends between the exhaust conduit 30 and the engine air inlet conduit 26 and is adapted to permit communication of exhaust gases from the engine 12 to be recirculated back into the engine via inlet conduit 26. The first EGR conduit 52 comprises a gas cooler 54 configured to cool the recycled exhaust gases. A valve 56 is provided to permit selective communication of exhaust gases through the first EGR conduit 52.

A second EGR conduit 58 extends between the exhaust conduit 30 and the engine air inlet conduit 26, and in this case the second EGR conduit 58 does not comprise a gas cooler, such that hot exhaust gases may be communicated to the air inlet conduit 26, if required. A valve 60 is provided to permit selective communication of exhaust gases through the second EGR conduit 58.

The apparatus 10 further comprises an oxygen enriched air subsidiary conduit 62 which extends between oxygen enriched air outlet conduit 20 and exhaust conduit 30, at a location upstream of the catalyst 46. The subsidiary conduit 62 includes a valve 64 to permit selective fluid communication of oxygen enriched air to the exhaust conduit 30.

The combustion apparatus 10 is controllable to be operated in different modes of operation and across a range of engine power outputs. A controller 24 may be utilised to control the combustion apparatus to reconfigure between the different modes of operation etc. The controller 24 is in communication with various components of the apparatus 10, such as the engine 12, valves and the like, for example via wired connections 66.

For the purposes of clarity and brevity of the present description, the combustion apparatus will be described in five different modes of operation, which should permit various features and aspects of the present invention to become apparent. The five different modes are: idling and low power spark ignition operation;

low power HCCI operation; medium power HCCI operation; high power HCCI operation; and medium to high power spark ignition operation. However, it should be understood that the combustion apparatus may be operated in a number of different modes of operation and the present invention should not be limited to the examples provided below. For example, the engine may be operated exclusively in a HCCI mode of operation, for example through all engine conditions.

### Idling and Low Power Spark Ignition Operation

In this mode, which may involve engine speeds in the region of 1000 RPM, intake air is separated into oxygen enriched air and nitrogen enriched air. Valve 36 in the nitrogen enriched air conduit 22 is opened to permit communication of the nitrogen enriched air to the engine 12, which is operated by spark ignition in a conventional manner. The air cooler bypass valve 44 is arranged to divert the nitrogen enriched air to bypass the air cooler 42. Additionally, the nitrogen enriched air may be permitted to bypass the supercharger 38 by valve 40, although a proportion of the air may be driven through the supercharger 38.

Valve 34 within the oxygen enriched air delivery conduit 20 is closed, whereas valve 64 within the subsidiary conduit 62 is opened to permit oxygen enriched air to be delivered to the exhaust conduit 30 and the catalyst 46 to provide increased oxygen for efficient oxidation of exhaust products, such as hydrocarbons and carbon monoxide. This is particularly advantageous in that the exhaust gases from the engine may comprise a very low quantity of oxygen in view of the use of nitrogen enriched air for combustion.

This mode of operation permits the engine to initially warm up and to assist to maintain a preferred engine temperature, while seeking to ensure exhaust emissions are within appropriate ranges.

### Low Power HCCI Operation

It is well understood in the art that HCCI operation is difficult to initiate and maintain, and that it is heavily dependent on establishing the correct conditions to achieve auto-ignition. The present invention permits very accurate control of the engine 12 and associated conditions, permitting HCCI operation to be more readily initiated and maintained, as discussed below.

Once HCCI operation is required valve 64 in subsidiary conduit 62 is closed, and valve 34 in the oxygen enriched air conduit 20 is opened to permit oxygen enriched air from the air processing unit 14 to be delivered to the engine 12 via inlet conduit 26. The increase in oxygen content in the combustion chamber increases the volatility of the air and fuel mixture promoting the initiation of HCCI combustion. Also, the increased oxygen content is considered to accelerate the combustion speed providing an enabler to transition from flame combustion to flameless combustion.

Bypass valve 50 is configured to divert the nitrogen enriched air through the exhaust gas heat exchanger 48 in order to be heated, prior to being delivered to the engine via conduit 26. Also, valve 60 in the second EGR conduit 58 is opened to permit hot exhaust gases to be delivered to the engine via inlet conduit 26. Accordingly, configuring the apparatus 10 in this manner permits the inlet air and gases to achieve a required temperature, which assists the initiation of HCCI combustion. In order to achieve more accurate control of the inlet air temperature to the engine, air cooler bypass valve 44 may be selectively controlled to provide a degree of air cooling, if required.

Furthermore, the continued supply of nitrogen, and the recycling of exhaust gases, permits the peak combustion temperatures within the engine 12 to be more readily controlled.

The engine 12 may eventually be reconfigured to cease operation of any sparking means, such as a spark plug, and initiate HCCI combustion operation.

In this mode of operation the engine may operate in the region of 1500 to 2000 RPM.

### Medium Power HCCI Operation

Once HCCI operation is initiated, and engine power is increased, for example to around the region of 2500 RPM, valve 34 is closed and valve 64 is opened in order to re-divert oxygen enriched air away from the engine 12 and back to the exhaust conduit 30. This may therefore decrease the mass of oxygen being supplied to the engine 12 to assist to minimise peak combustion temperatures, and to assist to maintain HCCI operation. Also, the oxygen enriched air will assist operation of the catalyst 46.

Within this mode of operation heated nitrogen enriched air and hot exhaust gases are supplied to the engine 12, with optional use of the air cooler 42.

### High Power HCCI Operation

Once the engine power has increased, for example to engine speeds in the region of 3000 to 3500 RPM, the supercharger bypass valve 40 may be closed such that all inlet air is compressed within the supercharger 38 to provide sufficient air induction to the engine 12.

It should be noted that the engine 12 includes variable compression means and variable valve timing which may be utilised to assist in initiating and maintaining HCCI operation.

### Medium to High Power Spark Ignition Operation

It may be desirable to return the engine to operate by spark ignition, for example when engine speeds are increased to the region of 3500 to 4000 RPM. This may be desirable to permit sufficient engine power output and/or meet appropriate fuel economy and exhaust emission levels.

In this mode the heat exchanger bypass valve 50 is closed, such that the nitrogen enriched air is not subjected to heating by the exhaust gases. Also, valve 60 in the second EGR conduit 58 is closed to prevent hot exhaust gases from being directed to the engine 12, while valve 56 in the first EGR conduit 54 is opened to deliver cooled recycled exhaust gases to the engine 12. Additionally, air cooler bypass valve 44 is arranged to divert all inlet air through the air cooler 42. These arrangements are made to ensure that the inlet air temperature is minimised, in order to assist to control peak combustion temperatures to minimise emissions, and particularly to minimise the formation rate of oxides of nitrogen.

It should be understood that the modes of operation of the engine are merely exemplary. For example, the engine may be operated by HCCI combustion, without initially requiring spark ignition combustion. Also, the spark ignition modes of operation may be replaced by compression ignition modes of operation.

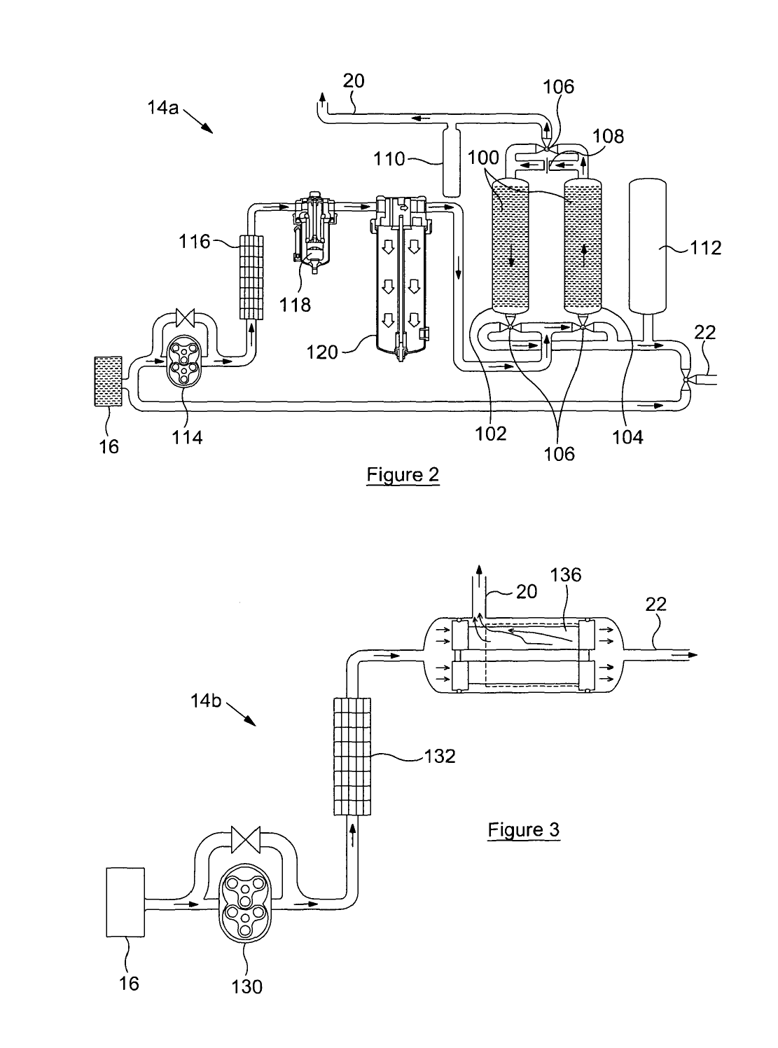

Reference is now made to FIG. 2 of the drawings in which there is shown an embodiment of the air processing unit 14 of FIG. 1. In this embodiment the air processing unit is generally identified by reference numeral 14a.

The air processing unit 14a functions by separating nitrogen and oxygen using a zeolite material 100 provided in canisters 102, 104. When under pressure the zeolite material 100 adsorbs nitrogen from inlet air while permitting oxygen to pass therethrough, and when vented to atmosphere the zeolite material 100 releases the nitrogen. Accordingly, the canisters 102, 104 are cyclically pressurised and vented via changeover valves 106, which preferably occurs out of phase to provide a relatively continuous outlet supply. Specifically, while canister 104 is pressurised, as shown in FIG. 2, to produce an oxygen stream to be delivered from the processing unit 14a via conduit 20, canister 102 is vented to release the nitrogen, which is delivered from the air processing unit 14a via conduit 22. To assist in purging of the canister 102, some oxygen may be delivered via conduit and orifice 108.

In the embodiment shown in FIG. 2, the air processing unit 14a includes an oxygen surge tank 110 and a nitrogen surge tank 112 to assist the provision of a substantially consistent flow via conduits 20 and 22.

The air processing unit 14a also comprises a compressor in the form of a supercharger 114, and an air cooler 116. Furthermore, a coalescing filter 118 is provided to remove water droplets, oil droplets and the like, and a desiccant air dryer 120 is provided to remove remaining moisture from the air to assist in ensuring separation efficiency of the zeolite material 100.

An air bypass conduit 122 extends from the air filter 16 to permit unprocessed air to be mixed with nitrogen enriched air to be delivered via conduit 20. This can assist in ensuring appropriate proportions of nitrogen and oxygen within the nitrogen enriched air for suitable operation of the engine 12.

An alternative embodiment of the air processing unit of FIG. 1 is shown in FIG. 3, wherein the air processing unit is generally identified by reference numeral 14b. In this embodiment inlet air is drawn through the air filter 16, is compressed by compressor 130, is cooled by an air cooler 132, and is then delivered to a separation module 134. The separation module 134 comprises one or more membrane arrangements 136 which function to separate oxygen and nitrogen, producing an oxygen enriched stream delivered via conduit 20, and a nitrogen enriched stream delivered via conduit 22.

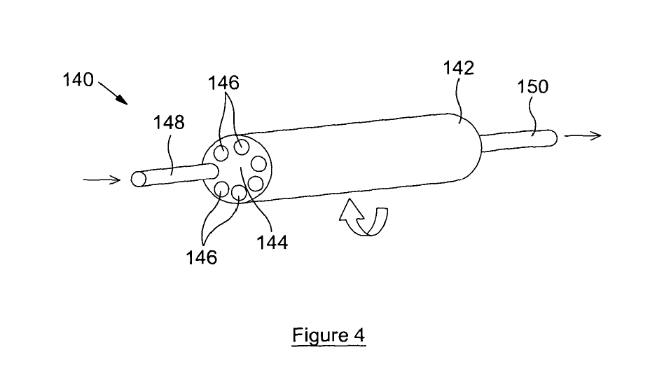

Reference is now made to FIG. 4 in which there is shown an air separator, generally identified by reference numeral 140, which is configured for use in separating oxygen and nitrogen from an air supply. The air separator 140 comprises a canister 142 rotatable about a central axis 144, wherein the canister comprises a plurality of circumferentially arranged chambers 146 comprising zeolite material. An air inlet 148 is configured to deliver air to be processed to the canister 142, and an outlet conduit 150 is provided to deliver oxygen enriched air from the canister 142. In use the canister is rotated to align one of the zeolite chambers 146 to receive inlet air via conduit 148, wherein nitrogen is adsorbed by the zeolite and oxygen is permitted to pass therethrough and exit via conduit 150. Once the zeolite in the aligned chamber becomes saturated the canister 142 is rotated to align a different zeolite chamber 146 with the inlet conduit 148, while permitting the previously aligned zeolite chamber to be vented and thus release the adsorbed nitrogen. The air separator 142 therefore permits rapid operation of the zeolite chambers to produce a more consistent output of oxygen and nitrogen enriched air streams.

Reference is now made to FIG. 5 in which there is shown a bonnet assembly 160 of a vehicle. The bonnet assembly 160 may be provided to close, such as selectively close, a compartment within the vehicle, such as an engine compartment. The bonnet assembly 160 comprises a bonnet 162, which may be formed of sheet metal, and an insert panel 164 configured to be secured to the bonnet 162. The insert panel 164 incorporates one or more components of an air processing unit configured to process air to be used by the vehicle, such as by an engine of the vehicle. In the embodiment shown the insert panel 164 comprises a zeolite material configured to separate inlet air into an oxygen enriched air stream and a nitrogen enriched air stream.

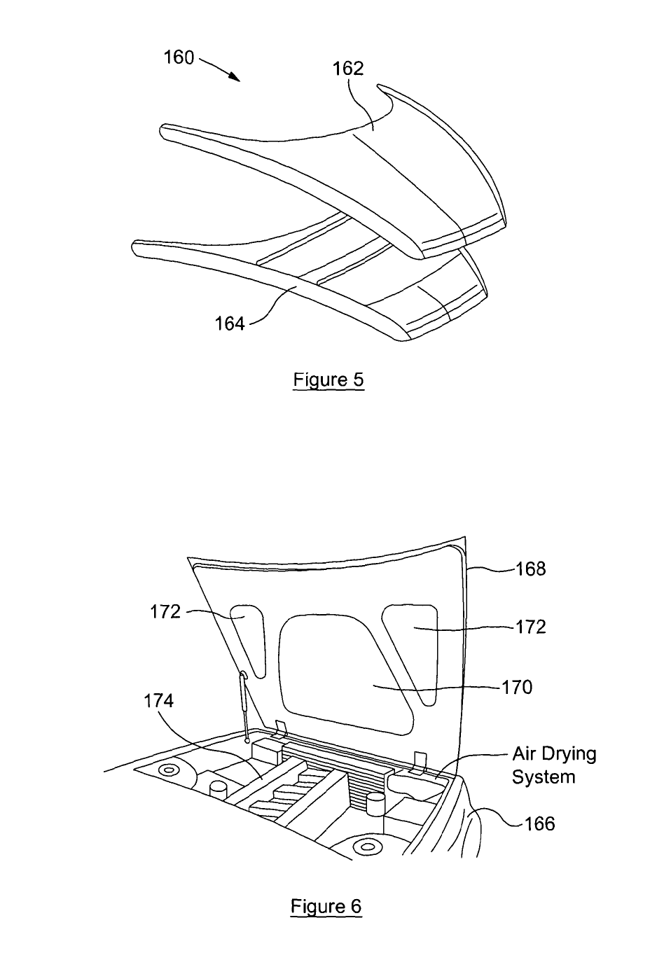

FIG. 6 of the drawings shown a vehicle 166 which includes an engine compartment bonnet 168, shown in an open configuration, which supports various components of an air processing unit, including zeolite separators 170 and surge tanks 172. Remaining components of the air processing unit may be located within an engine compartment 174 of the vehicle 166.

It should be understood that the embodiments described herein are merely exemplary and that various modifications may be made thereto without departing from the scope of the invention. For example, the air processing unit may be provided with any suitable apparatus, as would be selected by a person of skill in the art, which is suitable for separating oxygen and nitrogen from air. Furthermore, the air separator 140 shown in FIG. 4 is not limited for use in processing air, and the rotating canister concept may be used in the processing of any other mixture of gases, liquids or the like.

1. A method of operating a combustion apparatus having an engine and an air processing unit, the method comprising:
separating inlet air in the air processing unit into oxygen enriched air and nitrogen enriched air;
delivering oxygen enriched air to the engine and initiating homogeneous charge compression ignition combustion; and then
reducing the mass of oxygen enriched air being delivered to the engine and maintaining homogeneous charge compression ignition combustion.

2. The method according to claim 1, wherein the oxygen enriched air comprises between 30 to 100% oxygen purity.

3. The method according to claim 1, wherein nitrogen enriched air is supplied to the engine during the step of initiating HCCI combustion.

4. The method according to claim 1, wherein nitrogen enriched air is supplied to the engine when the mass of oxygen enriched air is reduced after HCCI combustion has been initiated.

5. The method according to claim 1, comprising initially delivering at least the nitrogen enriched air to the engine and operating the engine by one of compression ignition and spark ignition combustion, prior to the step of initiating HCCI combustion.

6. The method according to any preceding claim 1, wherein delivering oxygen enriched air to the engine and initiating HCCI combustion comprises increasing the mass of oxygen enriched air being delivered to the engine.

7. The method according to any preceding claim 1, wherein HCCI operation is initiated when predetermined engine conditions are satisfied.

8. The method according to claim 1, comprising switching between compression ignition or spark ignition and HCCI in accordance with engine conditions.

9. The method according to claim 8, wherein HCCI operation is initiated over low to high engine powers and compression ignition or spark ignition is initiated during idling and warm-up conditions, and during high engine power outputs.

10. The method according to claim 1, comprising heating air being supplied to the engine to achieve required air conditions.

11. The method according to claim 10, wherein air is heated via at least one of waste heat from engine exhaust gases, waste heat from an engine cooling system, waste heat from a vehicle occupant climate control system, heat generated by an electrically or mechanically operated heat exchanger, heat from an induction heater, heat from combustion within a separate combustion apparatus and heat generated from a chemical reaction.

12. The method according to claim 1, wherein the combustion apparatus comprises a cooling arrangement configured to cool at least a proportion of air being delivered to the engine.

13. The method according to claim 1, comprising recycling combustion exhaust gases to the engine.

14. The method according to claim 1, comprising delivering oxygen enriched air to a catalyst arrangement provided to process exhaust products from the engine.

15. The method according to claim 1, comprising supplying oxygen enriched air to a catalyst arrangement while nitrogen enriched air is supplied to the engine.

16. The method according to claim 1, comprising delivering oxygen enriched air to a catalyst arrangement, and then diverting at least a proportion of the oxygen enriched air to the engine to assist to initiate HCCI operation.

17. The method according to claim 16, comprising re-diverting at least a proportion of the oxygen enriched air being supplied to the engine to the catalyst arrangement after initiation of HCCI combustion within the engine.

18. The method according to claim 1, wherein the combustion apparatus comprises a variable compression engine.

19. The method according to claim 1, wherein the engine comprises a variable valve timing arrangement.

20. The method according to claim 1, wherein the air processing unit comprises a separating media configured to separate nitrogen and oxygen.

21. The method according to claim 20, wherein the separating media comprises a molecular filter arrangement.

22. The method according to claim 21, wherein the separating media comprises at least one of a membrane, a zeolite material and a plurality of nanotubes.

23. The method according to claim 20, wherein the air processing unit comprises a compressor configured to compress inlet air to be delivered through the separation media.

24. The method according to claim 1, wherein the air processing unit comprises an air cooler.

25. The method according to claim 1, wherein the air processing unit comprises an air dryer.

26. The method according to claim 1, wherein the air processing unit comprises a storage arrangement configured to store processed air.

27. The method according to claim 1, wherein the air processing unit comprises:
a canister containing a plurality of chambers each comprising a zeolite material;
an air inlet configured to deliver air to be processed to the canister;
wherein the canister and the air inlet are relatively moveable to sequentially align the plurality of zeolite chambers with the air inlet.

28. The method according to claim 27, wherein the canister is rotatable to sequentially align the zeolite chambers with the air inlet.

29. The method according to claim 1, wherein the combustion apparatus is provided in a vehicle, wherein at least one components of the air processing unit are mounted on a closure component of an vehicle engine compartment.

30. A combustion apparatus comprising:
an engine;
an air processing unit adapted to separate inlet air into nitrogen enriched air and oxygen enriched air to be selectively delivered to the engine,
wherein the combustion apparatus is configurable between first and second configurations, wherein:
in the first configuration oxygen enriched air is delivered to the engine and homogeneous charge compression ignition combustion is initiated; and
in the second configuration the mass of oxygen enriched air being delivered to the engine is reduced and homogeneous charge compression ignition combustion is maintained.

31. A combustion apparatus comprising:
an engine;
an air processing unit configured to separate inlet air into oxygen enriched air and nitrogen enriched air; and
a control arrangement configured to deliver oxygen enriched air to the engine and initiate homogeneous charge compression ignition combustion, and then reduce the mass of oxygen enriched air being delivered to the engine and maintaining homogeneous charge compression ignition combustion.
